(19) United States
(12) Patent Application Publication
(10) Pub. No.: US 2008/0277251 A1
(43) Pub. Date: Nov. 13, 2008

(54) Electrical switch apparatus and methods

(75) Inventors: Brett Tatman, Windsor, CO (US); Troy Diaz, Fort Collins, CO (US); Kevin Albertsen, Fort Collins, CO (US); Tim Tyner, Thornton, CO (US)

Correspondence Address: SANTANGELO LAW OFFICES, P.C., 125 SOUTH HOWES, THIRD FLOOR, FORT COLLINS, CO, 80521, US

(73) Assignee: Snaptron, Inc., Windsor, CO (US)

(21) Appl. No.: 11/801,630

(22) Filed: May 9, 2007

(51) Int. Cl. H01J 9/00

(52) U.S. Cl. 200/17 B

(57) ABSTRACT

Particular embodiments of the inventive technology may relate to an electrical switch apparatus, and related methods, that include a conductive contiguity, alone with which two sequential electrical contacts may be induced upon application of force by a user, thereby effecting two or more distinct electrical events. Embodiments of the inventive technology may more specifically include a conductive contiguity having a truncated leg that enables inducement of a first electrical contact before a second, subsequential contact is induced.

### I. BACKGROUND OF THE INVENTION

Electrical switches are, of course, well known, and have been used in various applications for many years. A typical electrical switch controls electrical flow as desired or appropriate for a given application or function, and is an important component in thousands of apparatus, from household appliances to vehicles to communication devices, as but a few examples. Often one switch enables control of power delivery to subsequently effect more than one electrical event. It is such switches on which particular embodiments of the inventive technology focus.

Switches that control power delivery in sequential fashion to effect more than one electrical event are well known. Certain types of tactile dome switches, which may be of the pushbutton type, include two domes relatively arranged so that a single applied force (e.g., from a finger of a user) can sequentially effect two distinct electrical events (e.g., delivery of power first to one lamp, and then, later, to a different lamp). Such switches may find use in shutter buttons of cameras, as but one of many applications. Often such double dome type switches include two domes stacked upon each other—depression of the upper dome may, upon contacting top of the lower dome, effect a first electrical event; continued depression of the upper dome may force the lower dome to contact a conductor under the lower dome.

However, such conventional dome switches are not without their drawbacks. Their inherent reliance on two domes for switch functionality means more parts that can malfunction; their dependence on contact between the movable domes means greater possibility of switch malfunction and possible high rate of wear. Further, such switches are often encased above, instead of directly secured to, an underlying surface, and as such, result in an often undesirable freedom of movement of the domes relative to one another and to their surrounding encasement. Such freedom of movement can, particularly in those applications where the switch is often moving (heavy equipment applications, vehicular applications, cell phones, as but a few examples) compromise functionality; manufacturing of the encasement itself can be labor intensive. It is these drawbacks that various aspects of the inventive technology seek to address.

### II. BRIEF SUMMARY OF THE INVENTION

The present invention includes a variety of aspects which may be selected in different combinations based upon the particular application or needs to be addressed. In one basic form of the inventive technology an electrical switch apparatus 1 includes a conductive contiguity 2, alone with which two sequential electrical contacts may be induced upon application of force by a user, thereby sequentially effecting two or more distinct electrical events. Other embodiments of the inventive technology may more specifically include a conductive contiguity having a truncated leg 3 which enables inducement of a first electrical contact before a second, subsequent contact is induced. Naturally, as a result of these several different and potentially independent aspects of the inventive technology, the objects thereof are quite varied.

It is an object of at least one embodiment of the inventive technology to provide a switch having a contiguity (i.e., a single contiguity) that can, upon reconfiguration of that contiguity alone, induce more than one distinct electrical contact.

It is an object of at least one embodiment of the inventive technology to provide an economic design for a switch with which an operator is able to sequentially induce a plurality of distinct electrical contacts.

It is an object of at least one embodiment of the inventive technology to provide a switch with which a user thereof can sequentially induce a plurality of electrical contacts, where such switch obviates the aforementioned high wear of conventional double dome switch designs (therefore having a longer operational life).

It is an object of at least one embodiment of the inventive technology to provide a switch with which a user thereof can sequentially induce a plurality of electrical contacts, where such switch obviates the aforementioned risks of malfunction associated with conventional double dome switch designs.

It is an object of at least one embodiment of the inventive technology to provide a switch with which a user can sequentially induce a plurality of electrical contacts, where manufacture of such switch is, in at least certain respects, less expensive than manufacture of convention double dome switch designs.

It is an object of at least one embodiment of the inventive technology to provide a switch that is economic in manufacture and function, and easily replaceable.

Naturally further objects of the inventive technology are disclosed throughout other areas of the specification and claims.

### III. BRIEF DESCRIPTION OF THE SEVERAL VIEWS OF THE DRAWINGS

It is noted that any specifications, whether dimensional or otherwise, are merely exemplary, and do not in any way limit the scope of the inventive technology.

FIG. 1 shows a perspective view of an embodiment of the inventive technology in a first configuration.

FIG. 2 shows a perspective view of an embodiment of the inventive technology in a second configuration.

FIG. 3 shows a perspective view of an embodiment of the inventive technology in a third configuration.

FIG. 4 shows an overhead view of an embodiment of the inventive technology.

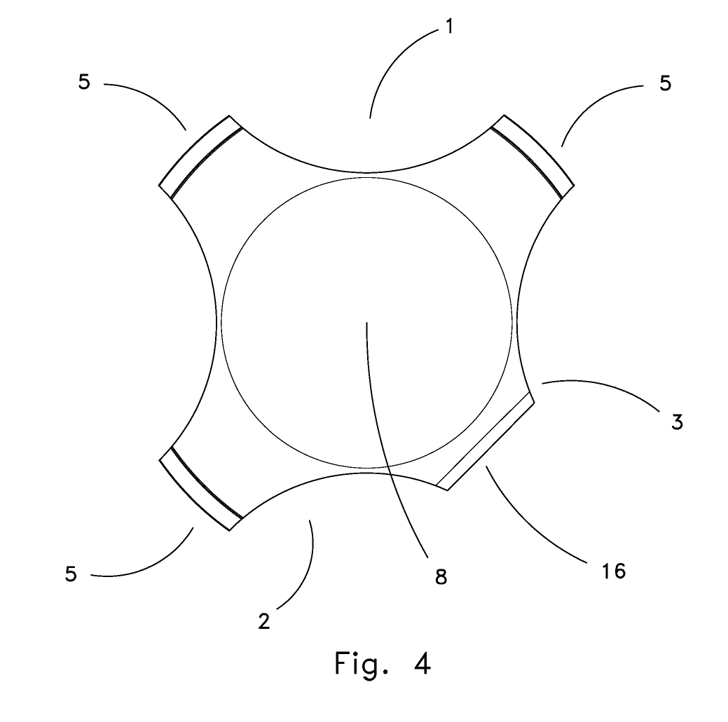

FIG. 5 shows an overhead view of an embodiment of the inventive technology.

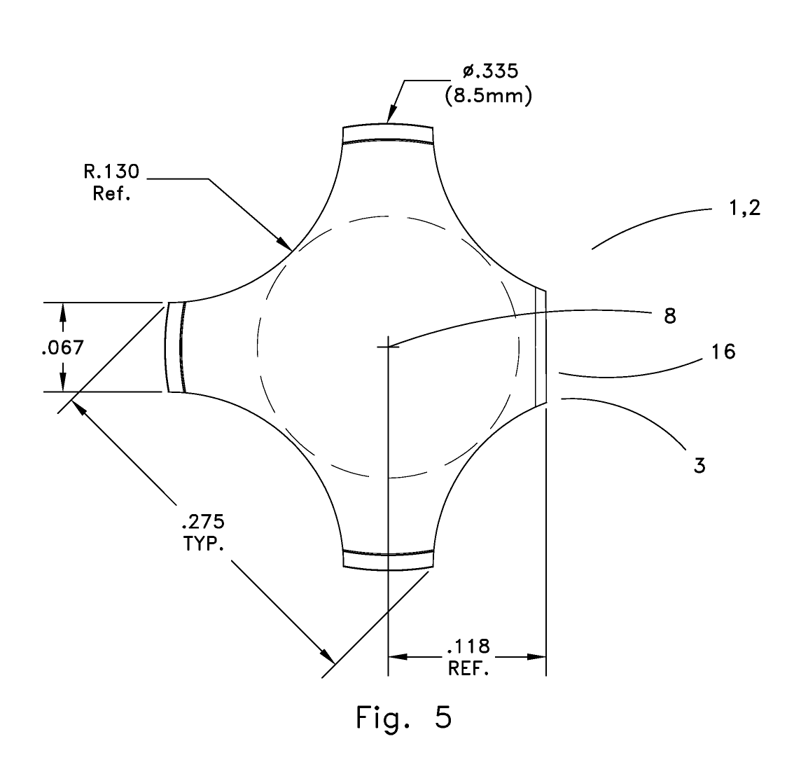

FIG. 6 shows an overhead view of a conductive contiguity, in transparent form, and trances of a printed circuit board beneath.

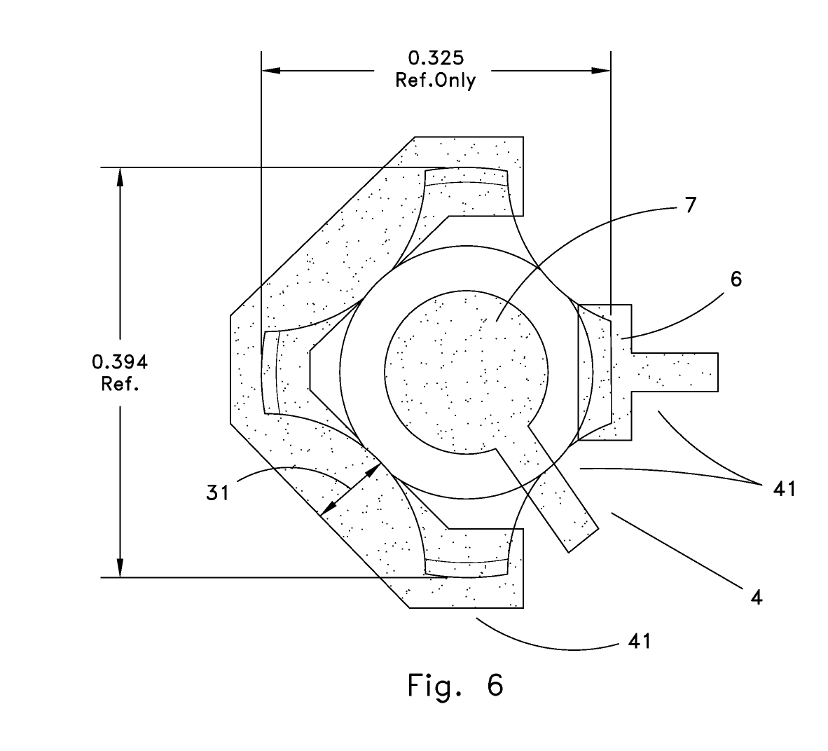

FIG. 7 shows an underside view of an embodiment of the inventive technology.

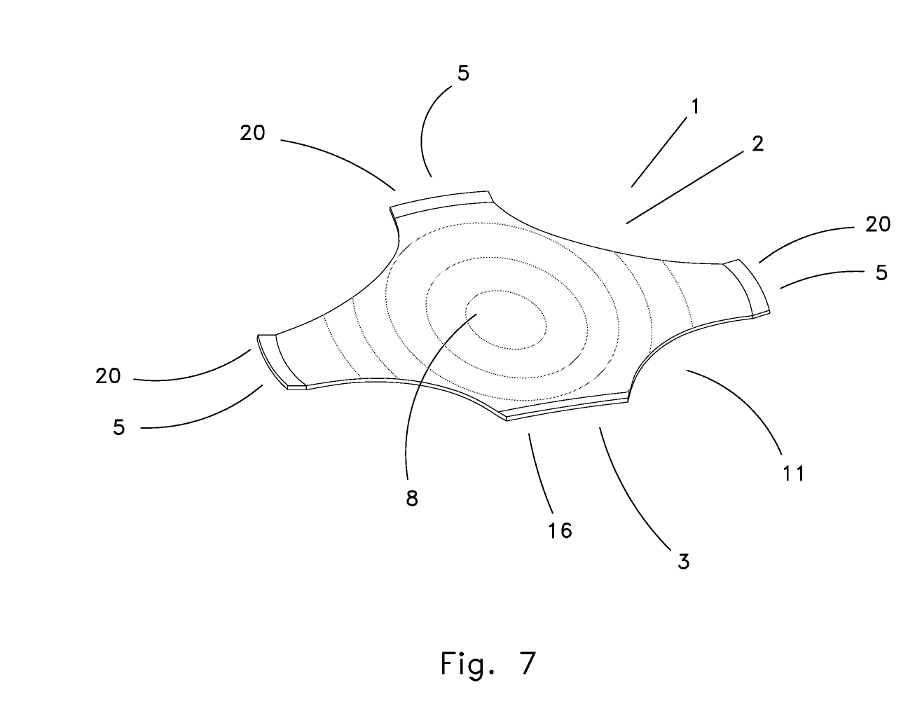

FIG. 8 shows a side view of an embodiment of the inventive technology, with a canopy shown in cross-section.

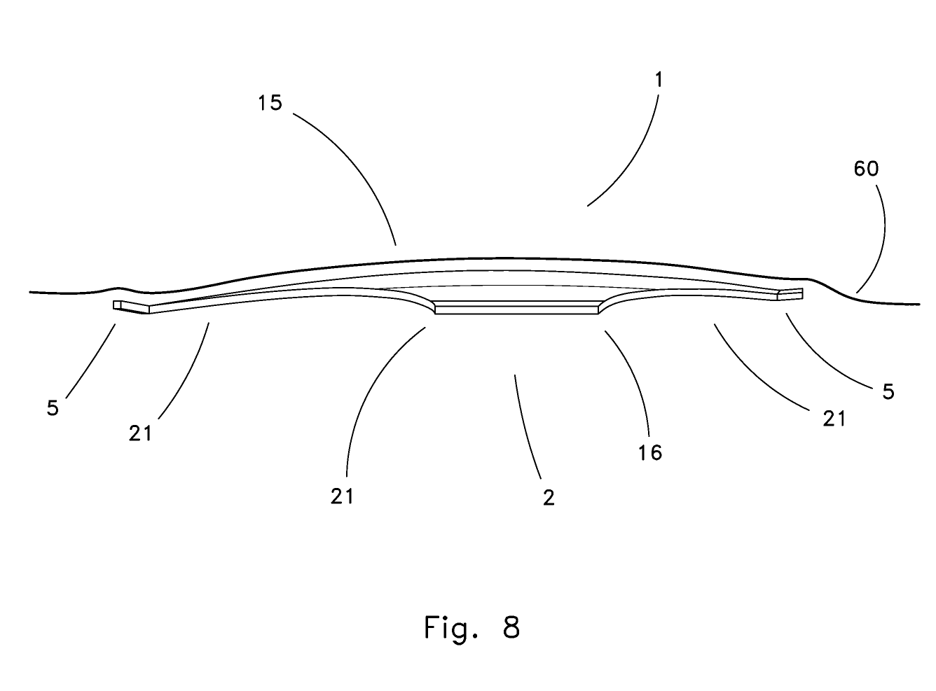

FIG. 9 shows a side view of an embodiment of the inventive technology.

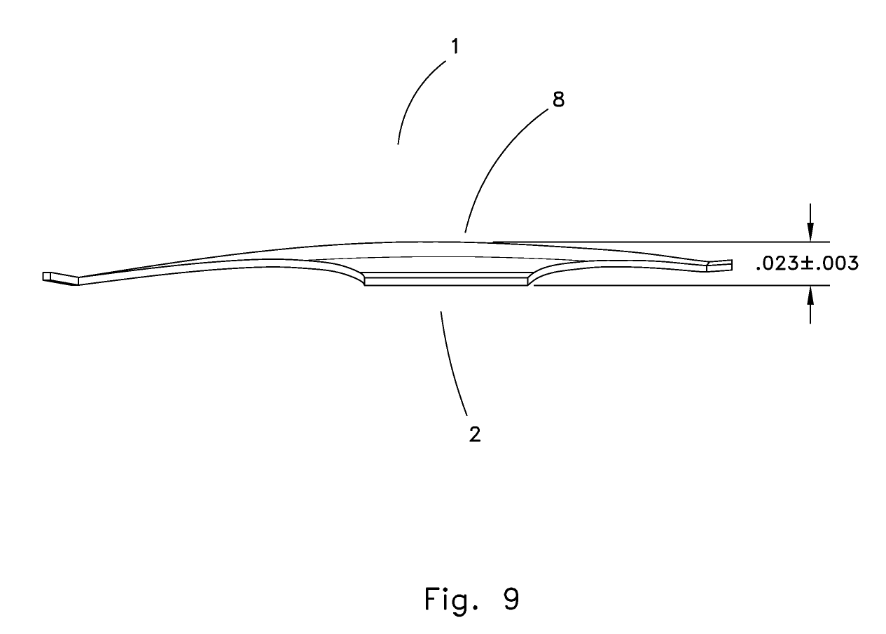

FIG. 10 shows a perspective view of an embodiment of the inventive technology.

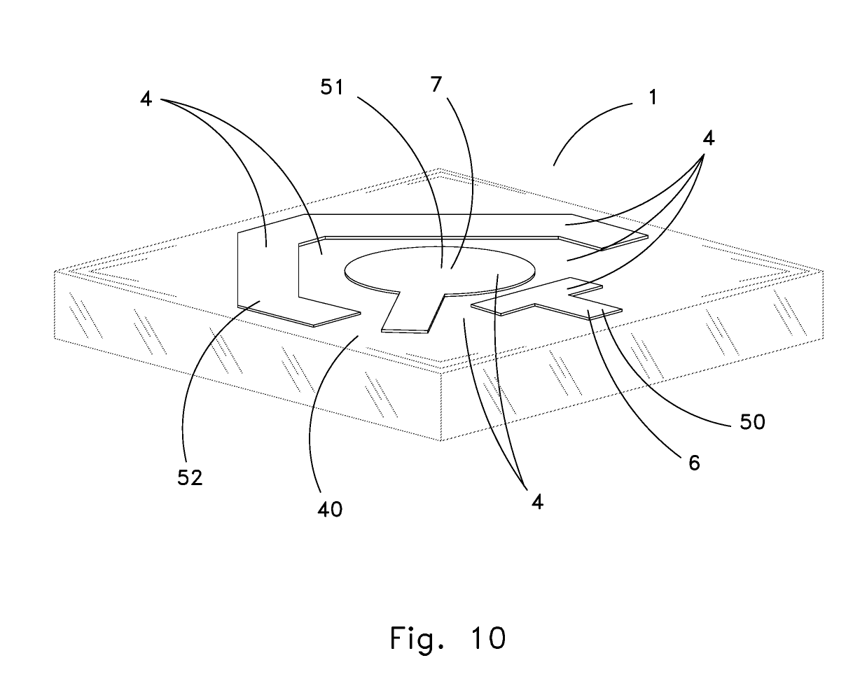

FIG. 11 shows a side view of an embodiment of the inventive technology, in first configuration.

FIGS. 12A, B and C show, respectively, a vertical cross-sectional view of a conductive contiguity in a first, second, and third configuration, respectively, in relation to electrical conductors of an underlying surface.

FIGS. 13A and B show two different examples of possible conductive contiguity designs.

FIG. 14 shows an additional example of a possible conductive contiguity design.

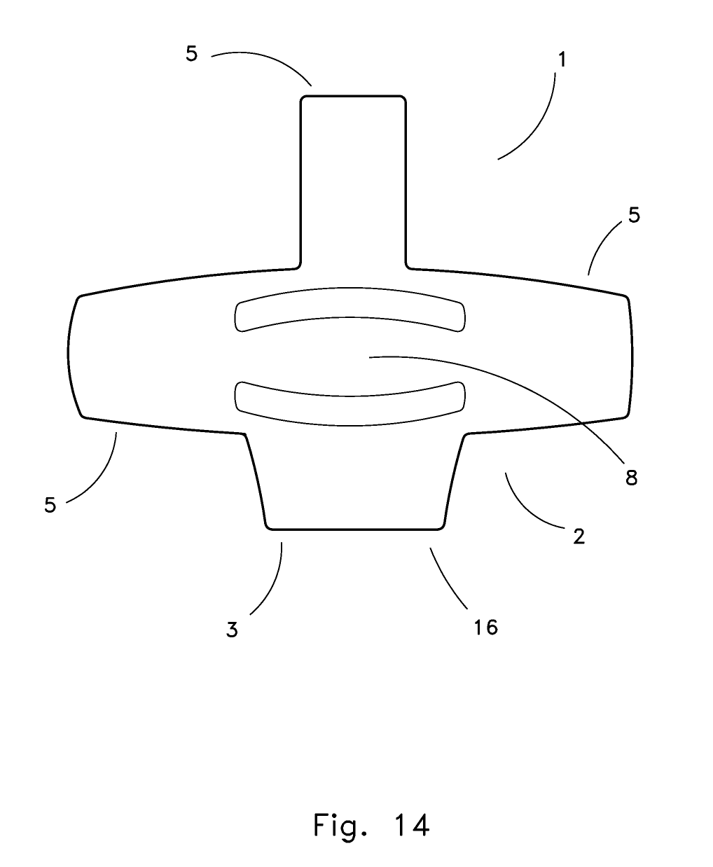

FIG. 15 shows a force versus displacement graph characteristic of a conductive contiguity of an embodiment of the inventive technology.

FIGS. 16A, B and C show, respectively, electrical schematics depicting an electrical open condition (as may be observed when the conductive contiguity is in a first configuration), a single contact electrical condition (as may be observed when the conductive contiguity is in a first configuration), and a double contact electrical condition (as may be observed when the conductive contiguity is in a first configuration), respectively.

### IV. DETAILED DESCRIPTION OF THE INVENTION

As mentioned earlier, the present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

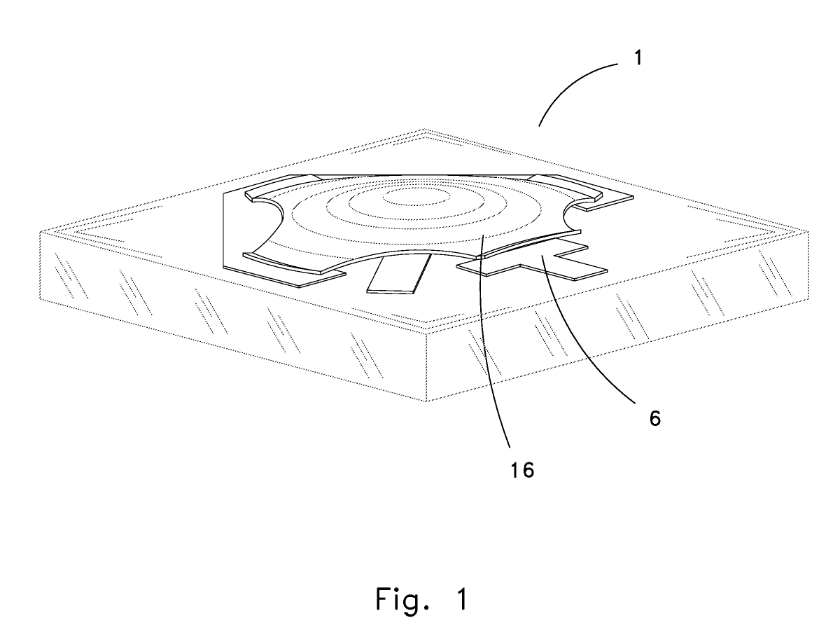

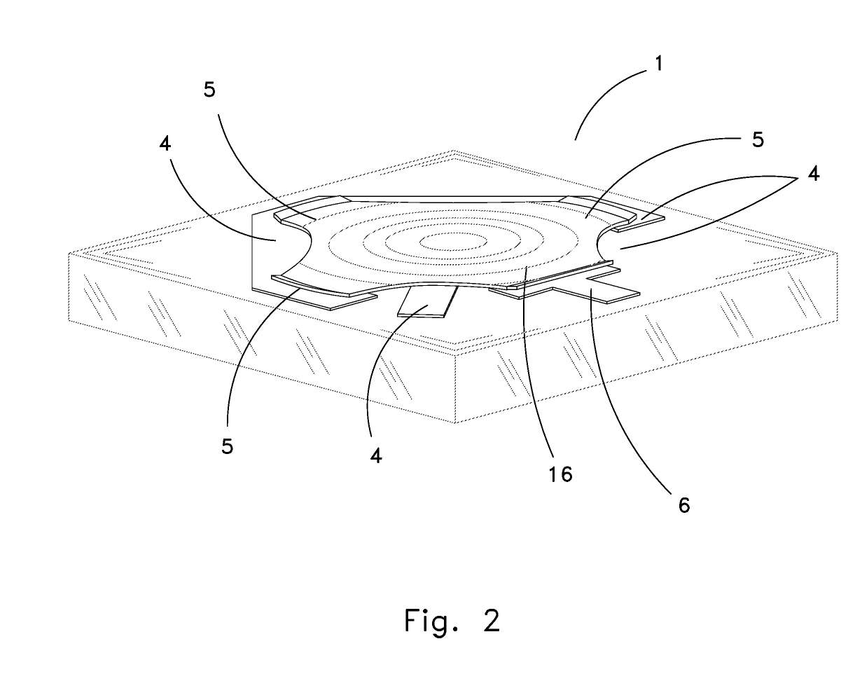

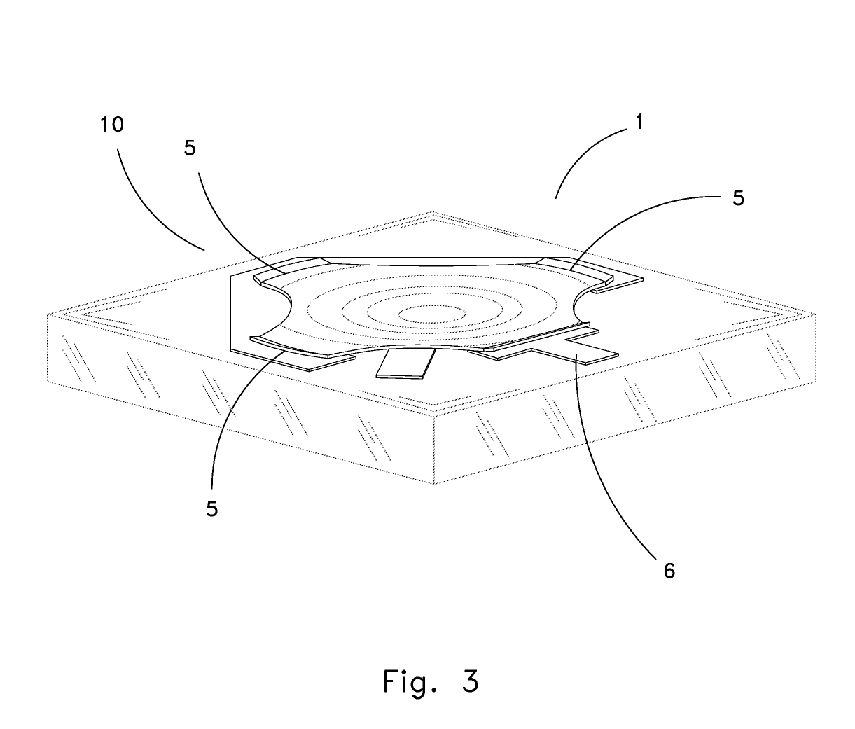

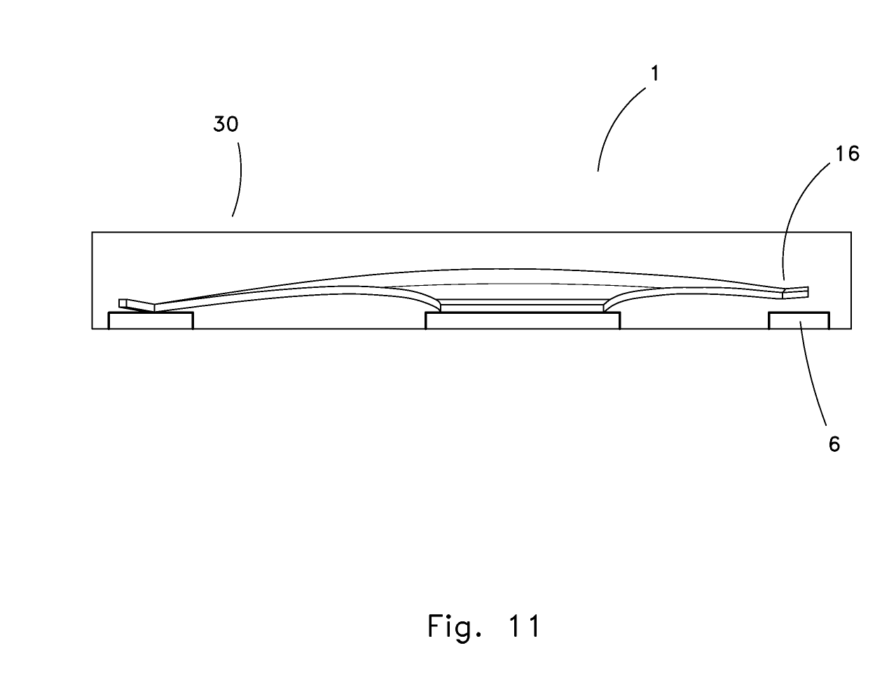

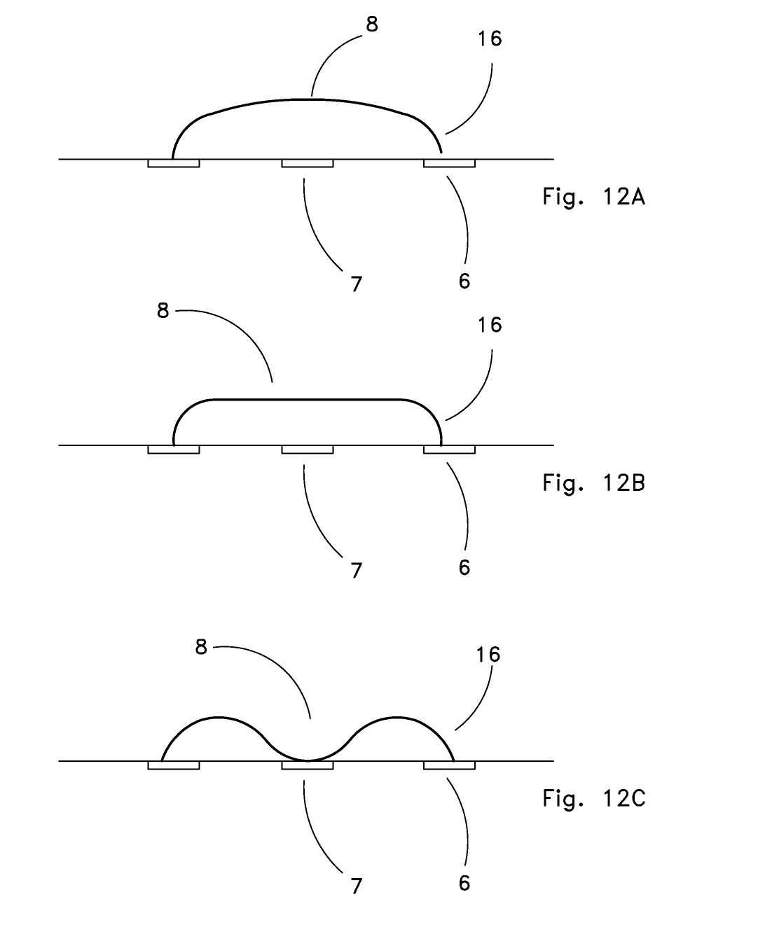

Particular embodiments of the inventive technology may be an electrical switch apparatus 1 that comprises a conductive contiguity 2 established above an underlying surface 4 and sequentially reconfigurable from a first configuration (see, e.g., FIGS. 1, 11 and 12A) to a second configuration (see, e.g., FIGS. 2 and 12B) to a third configuration (see, e.g., FIGS. 3 and 12C); at least one first configuration support portion 5 in contact with the underlying surface when the conductive contiguity is in the first configuration; at least one distinct first induced electrical contact portion 16 of the conductive contiguity 2 that is not in contact with a first electrical event conductor 6 of the underlying surface when the conductive contiguity is in the first configuration and in contact with the first electrical event conductor when the conductive contiguity is in the second configuration; and at least one distinct second induced contact portion 8 of the conductive contiguity that is not in contact with a second electrical event conductor 7 of the underlying surface when the conductive contiguity is in the first configuration and the second configuration. It is of note that the at least one distinct second induced contact portion 8, in a preferred embodiment, is in contact with the second electrical event conductor 7 when the conductive contiguity 2 is in the third configuration, and that the conductive contiguity is established to receive a force that effects sequential reconfiguration of the conductive contiguity from the first configuration to the second configuration to the third configuration. It is of note that the entire thickness of a respective portion of the contiguity may be deemed a contact portion, even though only the lower surface of such portion may make contact.

As used herein, the term electrical switch apparatus 1 may include, but is not limited to, an entire electrical switch, and the components thereof. For example, it may refer to an entire tactile dome switch 10 (a type of dome switch apparatus) or merely a component(s) thereof (such as simply the dome 11 itself, also a type of dome switch apparatus). The term dome is intended to encompass not only those parts that resemble a dome as that term is used in the dome switch field, but, indeed, also those parts that may resemble only parts of domes, or even perhaps simply curved or bent strips of material that may be reconfigurable as the application demands. Typically, such domes will have a curved surface, with an apex, or highest point, often at the dome's center (center herein define of the shape of a hypothetical contiguity without legs).

In dome switches, that part typically referred to as the dome in the dome switch field is a conductive contiguity, which itself includes all conductive parts that are in conductive contact that is not broken through or during normal operation of the switch. Further limitations on the scope of conductive contiguity may be imposed by the context in which the term is used. For example, if a conductive contiguity is to be established above an underlying surface, then any conductive materials that are in the aforementioned “continuous” contact but that are part of the underlying surface are not part of such conductive contiguity. An example of a conductive contiguity established above an underlying surface is the dome of an embodiment of the inventive technology. The underlying surface 4, a conductive part of which (e.g., a circuit board trace) the dome may be in contact with throughout operation of the dome, is not considered part of the conductive contiguity established there-above. It is also of note that the underlying surface may be substantially planar (as is the case even with a printed circuit board having traces), or it may be irregular; where it has any portions thereof able to conduct electricity, the underlying surface is deemed conductive.

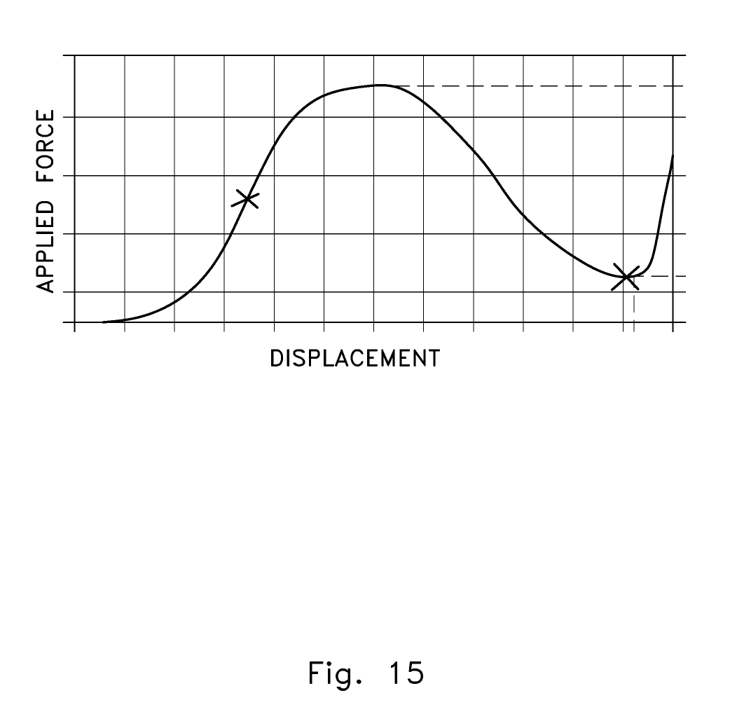

Particular embodiments of the inventive technology may include a conductive contiguity that is sequentially reconfigurable from a first configuration to a second configuration to a third configuration. As is readily understood, such limitation refers to a temporal ordering of events; a conductive contiguity so characterized can be reconfigured, through deformation and/or change in orientation relative to any underlying surface (including merely change in elevation above) or otherwise, from a first configuration, then to a distinct second configuration, and then to a distinct third configuration. Reference is made to FIGS. 12A, B and C, depicting a conductive contiguity in first, second and third configurations, respectively. In particular embodiments, the first configuration may be referred to as a relaxed configuration (e.g., unstressed, as may be the case when no force is applied to the contiguity), the second configuration, a mezzo-displacement configuration (as may be the case where a part of the contiguity (e.g., a centroidal or center portion) is displaced from 30% to 70% of its maximal operational displacement), and the third configuration, a maximal operational displacement configuration. As one may intuit, the maximal operational displacement configuration may refer to that configuration of the contiguity where a portion thereof (particularly a contacting portion thereof, e.g., a center) is displaced to the maximal extent observed during switch operation. It is of note that even when a contiguity is in a maximal operational displacement configuration, there may be parts of such contiguity that, upon application of even more force, may continue to displace (e.g., displace towards the underlying surface), as shown in FIG. 15. However, for clarity reasons, such additional displacement may be effectively ignored, as such displacement typically does not lend additional operational capability and may be properly viewed as a design artifact. In certain embodiments (e.g., those where the conductive contiguity is resilient), release, or even reduction perhaps, of a force holding the contiguity in a maximal operational displacement configuration may result in its return to the second configuration (e.g., mezzo-displacement configuration), and then, if the reduction of the force is sufficient, to the first configuration (e.g., relaxed configuration). Of course, upon reaching the first configuration, the switch should be ready for a subsequent actuation or use.

In particular embodiments, when the conductive contiguity is in the first configuration, at least one first configuration support portion 5 may be in contact with the underlying surface 4. A first configuration support portion may be simply that portion(s) that, when the conductive contiguity is in a first configuration, provides support to the conductive contiguity. It may be a part of the conductive contiguity, and indeed, in a preferred embodiment is, but need not be. In those embodiments where reconfiguration of the conductive contiguity is achieved via deformation thereof, the conductive contiguity may be deemed a deformable conductive contiguity 15.

As mentioned, in particular embodiments of the inventive technology, the conductive contiguity may include at least one distinct first induced electrical contact portion 16 that is not in contact with a first electrical event conductor 6 of the underlying surface when the conductive contiguity is in the first configuration, but that is in contact with the first electrical event conductor 6 when the conductive contiguity is in the second configuration. The term distinct merely indicates that it is distinguishable (merely because it may be a different part) from other induced electrical contact portion(s) that may exist; the term induced indicates that the contact may somehow be caused during operation of the switch (e.g., by a human user applying a force, either directly or indirectly, to the conductive contiguity). First induced is a temporal characterization; a first induced contact is made (or induced) before a second induced contact is made. The first electrical event conductor 6 is an electrical conductor (a trace of a circuit board, or a wire, as but two limitations) that conducts electricity in order that a first electrical event occur (e.g., a lighting of a lamp of a certain color, the generation of a sound, the reading of a particular parameter such as light intensity or capacitance, as but two of many examples). In particular embodiments, such electrical flow may first occur (e.g., the first electrical contact may be induced) when the conductive contiguity is reconfigured to the second reconfiguration. In typical applications where the switch might merely control the sequential delivery of power to various electrical components, the electrical diagram can be very easily prepared. Other more complex applications would still be well within the purview of an electrical engineer of ordinary skill in the art, once the inventive concept was explained to him or her.

As mentioned, contact of the at least one distinct second induced contact portion 8 with the second electrical event conductor 7 when the conductive contiguity is in the third configuration may effect the occurrence of a second electrical event. Indeed, just as the second configuration may exist when the first contact is induced, the third configuration may exist when the second contact is induced. It is of note that the second electrical event, induced after the inducement of the first electrical event, may nonetheless be related to or associated with the first event in some fashion. Perhaps the second event only properly occurs after a certain condition—perhaps reachable only by the user of the switch during the first event—is attained. As but one example, perhaps the switch informs the user of a camera when, because of the user's partial depression of a shutter button, a photograph is about to be taken. Of course, such incipient photographic condition is an ideal time to focus; the second event may allow the photographer to focus at such time in order that the further incremental depression of the shutter button yields a properly focused photo. Of course this is merely one of many examples of applications of embodiments of the instant technology. Others, generally, include but are not limited to applications, whether keyboard, pushbutton, number pad or other, requiring a graduated (e.g., high/low; incipient/final) type of control.

A first electrical event, induced before the inducement of a second electrical event, may be short-lived in that its occurrence may begin and end upon reconfiguration of the conductive contiguity to the indicated configuration or, indeed, such event may be longer, including but not limited to lasting up until (or even through) the contiguity's reconfiguration to a third configuration. Of course, the contiguity, particularly where it is a resilient conductive contiguity 20, may be reconfigured back from a third configuration to the first configuration (as, indeed, the preferred embodiment is a reusable type of switch), and, indeed, in preferred embodiments, during such negative reconfiguration, the contiguity may pass through the second configuration. Typically, but not necessarily, during negative reconfiguration, the order of electrical event actuation observed is simply the temporal reverse of that observed during positive reconfiguration (e.g., positive deformation). However, it is of note that in certain operational applications, negative reconfiguration may be so quick that the first electrical event may be, for practical purposes, unobservable. Such asymmetric operational behavior may be attributed primarily, but perhaps not exclusively, to the need by the operator for occurrence of the electrical event only during positive configuration of the contiguity.

It is of note that the first configuration may effect a first electrical condition (e.g., an open electrical condition), the second configuration may effect a second electrical condition (e.g., a single contact electrical condition, where there is only one operation-induced contact that is intact), and the third configuration may effect a third electrical condition (e.g., a double contact electrical condition, where two operation-induced contacts are intact). It is of note that even in those embodiments with sequential inducement of distinct electrical contacts, it may indeed be that the first induced contact remains intact while the second induced contact is induced. Indeed, the at least one distinct first induced electrical contact portion 16 of the conductive contiguity may be in contact with the first electrical event conductor 6 when the conductive contiguity is in the third configuration. It is of note that this is certainly not a requisite feature of the inventive technology, as indeed the each the second configuration and the third configuration may effect two distinct single contacts.

In certain embodiments of the inventive technology, the conductive contiguity 2 is established to receive a force that effects sequential reconfiguration of the conductive contiguity from the first configuration to the second configuration to the third configuration. Such force may be applied directly by a human user (e.g., where a finger contacts the contiguity, or is only de minimally separated therefrom (perhaps a piece of adhesive tape separates the skin of the finger from the contiguity)), or indirectly by a human user (e.g., where various structural or other componentry (a pushbutton, as but one example) is directly contacted by the human user).

As may be the case with a dome switch (or indeed other types of the apparatus), the conductive contiguity 2 may exhibit a threshold force type displacement during reconfiguration. In a preferred embodiment, such threshold force type displacement occurs during reconfiguration of the conductive contiguity 2 from the second configuration to the third configuration. Such threshold force type displacement may refer to a response by the contiguity whereby the slope of the applied force (vertical axis) versus displacement of contiguity center (horizontal axis) is negative (see, e.g. FIG. 15, which also shows points at which the first (left-most “x”) and second induced electrical contacts (right-most “x”) may appear). Such threshold force type displacement may be observed upon application of a force profile (a term that considers force and duration thereof) necessary to effect displacement, as shown in FIG. 15. Of course, as is clear, the concept of force profile (which considers temporal variations in applied force) must be used for certain embodiments because in order for the third configuration to be reached, not only must a force be applied that is greater than the maximum threshold force (the peak of the graph in FIG. 15), but also, a subsequent force of sufficient amount (typically less than the maximum threshold force), and duration, must be applied. An application having such a history may be said to match or exceed a threshold force profile.

As one might intuit, in certain embodiments, such a threshold force type displacement may also refer to the displacement of a portion of the contiguity (e.g., a center portion) that, upon application of a force that matches or exceeds a threshold force profile, yields, during at least a portion of the time such force profile is observed, at a displacement per instantaneously applied force rate that is greater than that displacement per instantaneously applied force rate observed during application of a force that is less than the threshold amount. Such may be a type of yield assist response. Of course, the term instantaneously applied force refers to that force that is actually applied at any point during reconfiguration of the switch. It is also of note that the threshold profile is observed, in certain embodiments (but perhaps not all), between the second configuration and the third configuration.

In FIG. 15, the left-most “x” shows where the first electrical contact may be induced (and where the second configuration may be observed), while the right most “x” shows where the second electrical contact may be induced (and where the third configuration may be observed). The graph's peak may be the maximum threshold force; it's low point at the bottom right may be the maximal operational displacement (occurring when the contiguity is in a third configuration). It is of note that, in the graph shown, the threshold force is 400±40 grams, the release force (force at third configuration which, when release, may result in reconfiguration of the contiguity to the first configuration) is 230 grams, the travel is 0.019 Ref., the thickness is 0.0035±0.0005, and the specific contiguity is rated for 5M cycles.

Among embodiments of the inventive technology, the at least one first configuration support portion 5 may comprise at least two downwardly extending protrusions 21 which may be considered legs 20. As long as some component of the protrusion extends downward, they are considered downwardly extending. In at least one embodiment, the at least one distinct first induced electrical contact portion 16 may also be viewed as a downwardly extending protrusion 21, and, indeed, a type of truncated leg 3 because it may be short enough not to contact the underlying surface when the contiguity is in the first configuration (indeed, it may be referred to as a leg even though it does not provide support in the first configuration). In particular embodiments, the at least one distinct second induced contact portion 8 may be a center portion of the conductive contiguity (although indeed, it may be a different portion thereof instead).

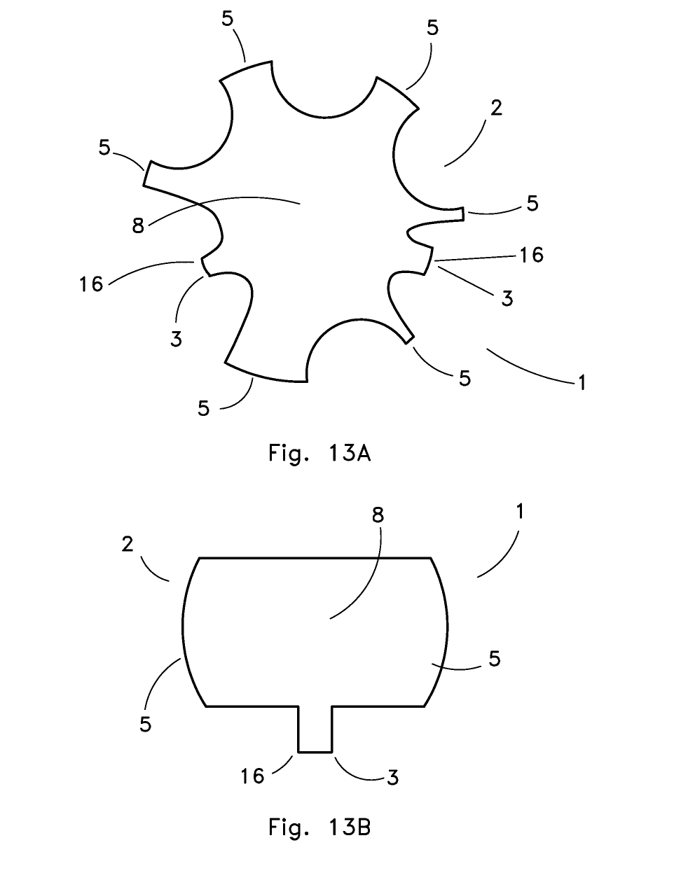

It should be noted that certain embodiments of the inventive technology may have more than one truncated leg (see, e.g., FIG. 13A). Where such truncated legs are of different lengths as in FIG. 13A (e.g., such that their respective elevations above any underlying surface are different), such legs may induce electrical contacts at different times. As such, more than one truncated leg, each having a different length, may afford more than one sequentially induced contact before a final contact. Indeed, in particular embodiments in which more than one contact may be sequentially induced, the last induced contact (often the second, but ever perhaps a third or fourth, as but a few examples)—and, indeed, all induced contacts, may be provided by truncated legs (although certainly the last induced contact may be provided by other than a truncated leg). Of course, where there is more than one truncated leg (and indeed, in any design), the underlying conductors will be arranged appropriately, as an engineer of ordinary skill in the art presented with the novel concept would understand.

It is of note that the orientation of the legs, whether truncated or not, need not be angularly symmetric (see, e.g., FIGS. 13A and 13B) about any circumference a particular dome design may have (although they certainly may be). Indeed, the orientations of legs may be asymmetric, and adjusted (e.g., during design) in order that any click response occur as desired. Additionally, the length of any truncated legs may be adjusted so that a certain force, or portion of the maximum threshold force effects a first induced contact as desired. In particular designs, it is noted that a truncated leg that is one-half the length of “non-truncated” legs will contact an underlying conductor upon application of approximately one-half the maximum threshold force.

When the conductive contiguity is in the first configuration, the at least one first configuration support portion 5 may be in contact with a conductor of the underlying surface that is distinct from each the first electrical event conductor 6 and the second electrical event conductor 7. Such contact may, in particular embodiments, enable current flow through the conductive contiguity to those conductors that the at least one distinct first induced electrical contact portion 16 and at least one distinct second induced electrical contact portions 8 contact. Of course, as is understood, such flow can be manipulated as desired, through various circuit and electrical components, to achieve desired effects.

It is of note that, in particular embodiments, the at least one first configuration support portion 5 may be in slideable contact with the conductor of the underlying surface that is distinct from each the first electrical event conductor 6 and the second electrical event conductor 7; such slideable contact may, for certain designs, allow for a predictable reconfiguration of the contiguity as desired. Slideable contact does not require sliding, but instead indicates that sliding contact is possible. It is of note that the extent to which contact is slideable may vary depending on how the contiguity is retained in operational position. For example, adhesive tape may reduce, or perhaps even eliminate slide, although most designs with tape will allow for slide; certainly soldering may eliminate slide. Encasements which allow for the conventionally known floating retention of domes may allow for the greatest amount of slide among particular contacts. In embodiments with slideable contact, the conductor of the underlying surface that is distinct from each the first electrical event conductor and the second electrical event conductor may have an enhanced width 31 in order to accommodate such sliding travel. Again, by way of example and not by limitation, it is noted that preferred embodiments of the inventive technology may include at least one distinct second induced contact portion 8 that is in point contact with the second electrical event conductor 7 when the conductive contiguity is in the third configuration.

In at least one embodiment, the underlying surface may be at least part of a circuit board 40 and the electrical conductors may be traces 41 thereof. In such, and indeed other, embodiments, the first electrical event conductor 6 may be an electrically isolated second edge electrical conductor 50 (isolated in that, at least in the area of the dome, and while the contiguity is not in relaxed configuration, it is not in contact with the other conductors of the underlying surface) that may be established immediately beneath the at least one distinct first induced electrical contact portion 16 of the conductive contiguity. Of course, as used herein, the term beneath, in addition to terms such as above, below, under, underlying, downwards, and upwards, are relative to any surface that the contiguity may be supported on. As such, an underlying surface is believed to still exist even where the surface and the contiguity are established in a vertical plane, or even obliquely, or upside down, as but a few examples. As such, it is not necessary, for example, that a user's applied force be towards the earth's center for such force to be downward.

In particular embodiments, the second electrical event conductor 7 may comprise a center electrical conductor 51 and the underlying surface 4 may include a conductor that is distinct from each the first electrical event conductor and the second electrical event conductor. Such conductor may be a first edge electrical conductor 52 established immediately beneath at least a portion of the at least one first configuration support portion(s) 5. Indeed, in certain embodiments, there may be only three conductors (in, in some embodiments, traces) of the underlying surface substantially beneath the contiguity 2. Some such embodiments may thereby avoid the need for an independent electrical path for bi-polar designs. Any of the conductors may be termed a power conductor in that it may deliver a positive voltage when contacted, in particular embodiments.

Particularly in those embodiments where the conductive contiguity exhibits a threshold force type displacement during reconfiguration, the conductive contiguity, when reconfigured from the first configuration to the second configuration and then to the third configuration, may make a click(s). In particular embodiments, only one click may be heard; such click typically, but not always, may occur during reconfiguration of the conductive contiguity from the second configuration to the third configuration. Indeed, such may be entirely expected in those embodiments where the conductive contiguity, when reconfigured from the second configuration to the third configuration, exhibits a threshold force type displacement. Instead of, or in addition to a click, the conductive contiguity, when reconfigured from the second configuration to the third configuration, may give a click feel to a user.

An aspect of the inventive technology may include an electrical switch apparatus that comprises a conductive contiguity, alone with which two distinct electrical contacts may be sequentially induced during positive reconfiguration of the conductive contiguity 2 by a user thereof. In such embodiments, two distinct electrical contacts may be sequentially induced during positive reconfiguration of the conductive contiguity alone—no other distinct parts or contiguities are needed to induce the referenced contacts. Such economic design is entirely different from those conventional designs requiring two or possibly even more parts or contiguities in order that two distinct contacts be induced. An aspect of the inventive technology may be an electrical switch apparatus that consists essentially of a conductive contiguity with which two distinct electrical contacts may be sequentially induced during positive reconfiguration of the conductive contiguity by a user thereof; and electrical conductors established substantially under the conductive contiguity.

In certain embodiments, the conductive contiguity, when established as part of the electrical switch, is unencased, a term referring to the absence of the conventionally known encasements that are used with certain dome switches. Certainly, however, embodiments of the inventive technology may employ an encasement. In certain embodiments (particularly unencased embodiments), the conductive contiguity, when established as part of the electrical switch, may be held in operative position with a canopy such as adhesive tape 60. In particular embodiments, such canopy may be adapted to avoid “preloading” of the contiguity (e.g., application, by the canopy, of a downward force onto the contiguity, present at least while the contiguity is in the first configuration). Such preloading may potentially increase the likelihood of the contiguity remaining in the third configuration upon force release where, in preferred embodiments, it is intended that the contiguity be resilient. Such canopy adaptation may include merely making at least one cut of the canopy, perhaps between any protrusions thereof, and towards that portion of the canopy that is over the center of the contiguity. Such cut, again, may help to avoid or at least relieve any preloading problems otherwise caused by the canopy. Such cut, particularly when placed near a truncated leg to relieve a truncated leg the contiguity may have (by relieving preloading stresses thereon), may afford the advantage of precluding rocking of the contiguity.

In certain embodiments, when used with a properly designed circuity board, the contiguity (e.g., a tactile dome) may allow for the sequential connection of two output circuits to a common input. The contiguity may be shaped so that two different parts thereof contact the underlying surface in sequence as force is applied at a single location. In certain embodiments (but by no means all embodiments), such sequential connection may be accomplished via a four legged dome having one of said legs truncated (e.g., shortened so, while the contiguity is in the first configuration, such truncated leg is not in contact with an underlying conductor). The other three legs may, while the contiguity is in the first configuration, contact a first edge electrical conductor 52 (established immediately beneath the at least a portion of the at least one first configuration support portion which, in this case, are the three aforementioned, non-truncated legs). In particular embodiments, such first edge electrical conductor may be a power conductor, or a common input conductor. In this example, when the contiguity is in the second configuration, the first electrical event conductor (in this example, the first output) is connected to the common input; when in the third configuration, the second electrical event conductor (the second output) and the first output are connected to the common input.

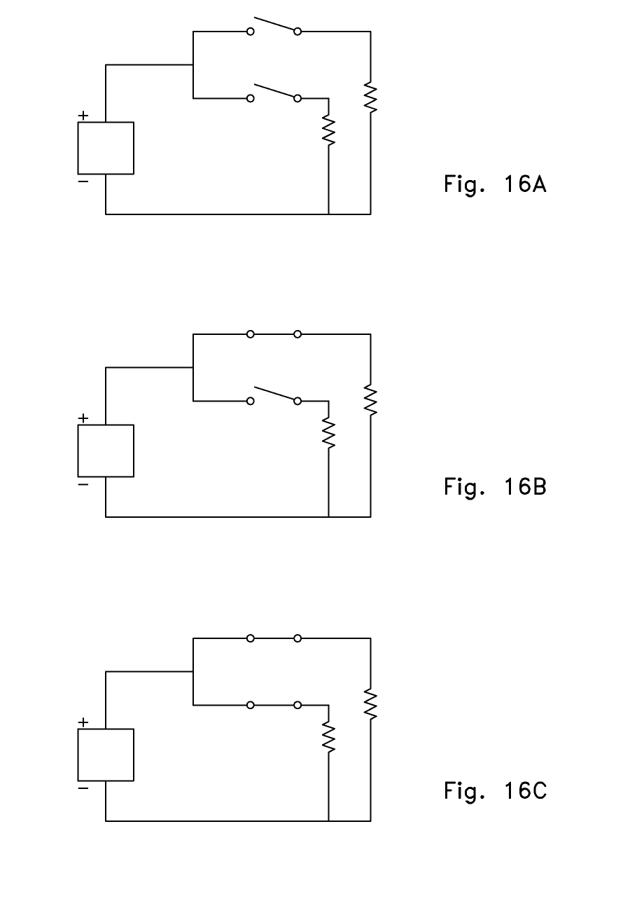

A simple electrical schematic may be used to show current flow, as governed by the switch, in an elementary application, as shown in FIGS. 16A-C. The switch itself may, be electrically mapped using two conventional switch symbols as shown in FIGS. 16A-C, given that two contacts are induced during operation of at least one embodiment of the inventive technology. Of course, FIG. 16A shows an electrically open condition, FIG. 16B shows a single contact electrical condition, and FIG. 16C shows a double contact electrical condition. Although the individual schematic switches (marked with conventional switch terminology) of each FIGS. 16A-C are shown as independently operable, in many applications, as explained above, the second contact will be induced (and, therefore the second, lower switch of each FIGS. 16A-C closed) only after the first contact has been induced and while that first contact is intact (i.e., while the upper switch of each FIGS. 16A-C is closed). It should be noted that, in using an electrical schematic to depict the electrical operation of particular embodiments of the inventive technology, certain particularities may arise: not only are two switch symbols used to represent the operation of a single switch as the term is understood herein, but also, the schematic appears to show four conductors (two for each pole). However, as discussed, in this particular embodiment(s), there are typically only three conductors under the contiguity. The discrepancy may be viewed as arising as a result of using a simple electric schematic to map current flow governed by what may be viewed as two basic “conceptual” switches that are operational with only a single contiguity. It is of further note that any power source may be direct or alternating current (the box at the left of each of FIGS. 16A-C is a generic power source).

It should be understood that the inventive technology includes not only inventive apparatus, but also inventive methods. Certain of the methods may involve the step of adapting a conductive contiguity to have certain features, qualities, or limitations; the term adapting may include manufacturing, whether by any of the well know manufacturing methods available today (e.g., molding, cutting, etc.).

An electrical switch method may comprise the steps of positively reconfiguring (e.g., by deforming) a conductive contiguity 2; inducing a first electrical contact while performing the step of positively reconfiguring the conductive contiguity; continuing to positively reconfigure the conductive contiguity; and inducing a second electrical contact while performing the step of positively reconfiguring the conductive contiguity and after completing the step of inducing a first electrical contact.

As can be easily understood from the foregoing, the basic concepts of the present invention may be embodied in a variety of ways. It involves both switching techniques as well as devices to accomplish the appropriate switching. In this application, the switching techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “switch” should be understood to encompass disclosure of the act of “switching”—whether explicitly discussed or not—and, conversely, were there effectively disclosure of the act of “switching”, such a disclosure should be understood to encompass disclosure of a “switch” and even a “means for switching” Such changes and alternative terms are to be understood to be explicitly included in the description.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the information disclosure statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the switching devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. Support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

What is claimed is:

1. An electrical switch apparatus comprising:
a conductive contiguity established above an underlying surface and sequentially reconfigurable from a first configuration to a second configuration to a third configuration;
at least one first configuration support portion that is in contact with said underlying surface when said conductive contiguity is in said first configuration;
at least one distinct first induced electrical contact portion of said conductive contiguity that is not in contact with a first electrical event conductor of said underlying surface when said conductive contiguity is in said first configuration and in contact with said first electrical event conductor when said conductive contiguity is in said second configuration; and
at least one distinct second induced contact portion of said conductive contiguity that is not in contact with a second electrical event conductor of said underlying surface when said conductive contiguity is in said first configuration and said second configuration,
wherein said at least one distinct second induced contact portion is in contact with said second electrical event conductor when said conductive contiguity is in said third configuration, and
wherein said conductive contiguity is established to receive a force that effects sequential reconfiguration of said conductive contiguity from said first configuration to said second configuration to said third configuration.

2. An electrical switch apparatus as described in claim 1 wherein said conductive contiguity exhibits a threshold force type displacement during said sequential reconfiguration.

3. An electrical switch apparatus as described in claim 2 wherein said threshold force type displacement occurs during reconfiguration of said conductive contiguity from said second configuration to said third configuration.

4. An electrical switch apparatus as described in claim 1 wherein said force is applied by a human user of said electrical switch apparatus.

5. An electrical switch apparatus as described in claim 1 wherein said electrical switch apparatus comprises a dome switch apparatus.

6. An electrical switch apparatus as described in claim 1 wherein said conductive contiguity is at least part of a dome.

7. An electrical switch apparatus as described in claim 1 wherein said conductive contiguity comprises a resilient conductive contiguity.

8. An electrical switch apparatus as described in claim 1 wherein said conductive contiguity comprises a deformable conductive contiguity.

9. An electrical switch apparatus as described in claim 1 wherein said at least one first configuration support portion comprises an at least one first configuration support portion of said conductive contiguity.

10. An electrical switch apparatus as described in claim 9 wherein said at least one first configuration support portion comprises at least two downwardly extending protrusions.

11. An electrical switch apparatus as described in claim 10 wherein said at least two downwardly extending protrusions comprises at least two legs.

12. An electrical switch apparatus as described in claim 1 wherein said at least one distinct first induced electrical contact portion comprises a downwardly extending protrusion.

13. An electrical switch apparatus as described in claim 12 wherein said downwardly extending protrusion comprises a truncated leg.

14. An electrical switch apparatus as described in claim 1 wherein said at least one distinct second induced contact portion comprises a center portion of said conductive contiguity.

15. An electrical switch apparatus as described in claim 1 wherein said first configuration is a relaxed configuration.

16. An electrical switch apparatus as described in claim 1 wherein said second configuration is a mezzo-displacement configuration.

17. An electrical switch apparatus as described in claim 1 wherein said third configuration is a maximal operational displacement configuration.

18. An electrical switch apparatus as described in claim 1 wherein said first configuration effects a first electrical condition.

19. An electrical switch apparatus as described in claim 18 wherein said first electrical condition comprises an open electrical condition.

20. An electrical switch apparatus as described in claim 1 wherein said second configuration effects a second electrical condition.

21. An electrical switch apparatus as described in claim 20 wherein said second electrical condition comprises a single contact electrical condition.

22. An electrical switch apparatus as described in claim 1 wherein said third configuration effects a third electrical condition.

23. An electrical switch apparatus as described in claim 22 wherein said third electrical condition comprises a double contact electrical condition.

24. An electrical switch apparatus as described in claim 1 wherein said at least one distinct first induced electrical contact portion of said conductive contiguity is in contact with said first electrical event conductor when said conductive contiguity is in said third configuration.

25. An electrical switch apparatus as described in claim 1 wherein, when said conductive contiguity is in said first configuration, said at least one first configuration support portion is in contact with a conductor of said underlying surface that is distinct from each said first electrical event conductor and said second electrical event conductor.

26. An electrical switch apparatus as described in claim 25 wherein said at least one first configuration support portion is in slideable contact with said conductor of said underlying surface that is distinct from each said first electrical event conductor and said second electrical event conductor.

27. An electrical switch apparatus as described in claim 26 wherein said conductor of said underlying surface that is distinct from each said first electrical event conductor and said second electrical event conductor has an enhanced width.

28. An electrical switch apparatus as described in claim 1 wherein said at least one distinct second induced contact portion is in point contact with said second electrical event conductor when said conductive contiguity is in said third configuration.

29. An electrical switch apparatus as described in claim 1 wherein said underlying surface comprises at least part of a circuit board.

30. An electrical switch apparatus as described in claim 1 wherein said first electrical event conductor comprises an electrically isolated second edge electrical conductor.

31. An electrical switch apparatus as described in claim 30 wherein said electrically isolated second edge electrical conductor is established immediately beneath said at least one distinct first induced electrical contact portion of said conductive contiguity.

32. An electrical switch apparatus as described in claim 1 wherein said second electrical event conductor comprises a center electrical conductor.

33. An electrical switch apparatus as described in claim 1 wherein said underlying surface further comprises a conductor that is distinct from each said first electrical event conductor and said second electrical event conductor.

34. An electrical switch apparatus as described in claim 33 wherein said conductor that is distinct from each said first electrical event conductor and said second electrical event conductor comprises a first edge electrical conductor is established immediately beneath at least a portion of said at least one first configuration support portion.

35. An electrical switch apparatus as described in claim 33 wherein said electrical conductors are traces of a circuit board.

36. An electrical switch apparatus as described in claim 1 wherein said conductive contiguity, when reconfigured from said first configuration to said second configuration and then to said third configuration, makes only one click.

37. An electrical switch apparatus as described in claim 1 wherein said conductive contiguity, when reconfigured from said second configuration to said third configuration, exhibits a threshold force type displacement.

38. An electrical switch apparatus as described in claim 1 wherein said conductive contiguity, when reconfigured from said second configuration to said third configuration, gives a click feel to a user.

39. An electrical switch apparatus as described in claim 1 wherein said conductive contiguity, when reconfigured from said second configuration to said third configuration, exhibits a yield assist.

40. An electrical switch apparatus as described in claim 1 wherein said conductive contiguity, when established as part of said electrical switch, is unencased.

41. An electrical switch apparatus as described in claim 40 wherein said conductive contiguity, when established as part of said electrical switch, is held in operative position with a canopy.

42. An electrical switch apparatus as described in claim 41 wherein said canopy comprises adhesive tape.

43. An electrical switch apparatus as described in claim 1 wherein said underlying surface comprises a conductive underlying surface.

44. An electrical switch apparatus as described in claim 1 further comprising said underlying surface.

45-86. (canceled)

87. An electrical switch apparatus comprising:
a conductive contiguity, alone with which two distinct electrical contacts may be sequentially induced during positive reconfiguration of said conductive contiguity by a user thereof.

88. An electrical switch apparatus as described in claim 87 wherein said conductive contiguity exhibits a threshold force type displacement during said positive reconfiguration.

89. An electrical switch apparatus as described in claim 87 wherein said electrical switch apparatus is a dome switch apparatus.

90. An electrical switch apparatus as described in claim 87 wherein said conductive contiguity is at least part of a dome.

91. An electrical switch apparatus as described in claim 87 wherein said conductive contiguity is a resilient conductive contiguity.

92. An electrical switch apparatus as described in claim 87 wherein said conductive contiguity is a deformable conductive contiguity.

93. An electrical switch apparatus as described in claim 87 wherein said positive reconfiguration is deformation of said conductive contiguity.

94. An electrical switch apparatus as described in claim 87 wherein said two distinct electrical contacts comprises at least one single contact.

95. An electrical switch apparatus as described in claim 94 wherein said two distinct electrical contacts further comprise a double contact.

96. An electrical switch apparatus as described in claim 87 wherein said positive reconfiguration of said conductive contiguity comprises reconfiguration from a first configuration to a second configuration to a third configuration.

97. An electrical switch apparatus as described in claim 96 wherein said first configuration comprises a relaxed configuration.

98. An electrical switch apparatus as described in claim 96 wherein said second configuration comprises a mezzo-displacement configuration.

99. An electrical switch apparatus as described in claim 96 wherein said third configuration comprises a maximal operational displacement configuration.

100. An electrical switch apparatus as described in claim 96 wherein said first configuration effects a first electrical condition.

101. An electrical switch apparatus as described in claim 100 wherein said first electrical condition comprises an open electrical condition.

102. An electrical switch apparatus as described in claim 96 wherein said second configuration effects a second electrical condition.

103. An electrical switch apparatus as described in claim 102 wherein said second electrical condition comprises a single contact electrical condition.

104. An electrical switch apparatus as described in claim 96 wherein said third configuration effects a third electrical condition.

105. An electrical switch apparatus as described in claim 104 wherein said third electrical condition comprises a double contact electrical condition.

106. An electrical switch apparatus as described in claim 96 wherein said conductive contiguity, when reconfigured from said first configuration to said second configuration and then to said third configuration, makes only one click.

107. An electrical switch apparatus as described in claim 96 wherein said conductive contiguity, when reconfigured from said second configuration to said third configuration, exhibits a threshold force type displacement.

108. An electrical switch apparatus as described in claim 96 wherein said conductive contiguity, when reconfigured from said second configuration to said third configuration, gives a click feel to a user.

109. An electrical switch apparatus as described in claim 96 wherein said conductive contiguity, when reconfigured from said second configuration to said third configuration, exhibits a yield assist response.

110. An electrical switch apparatus as described in claim 87 wherein said conductive contiguity comprises at least one first configuration support portion.

111. An electrical switch apparatus as described in claim 110 wherein said at least one first configuration support portion comprises at least two downwardly extending protrusions.

112. An electrical switch apparatus as described in claim 87 wherein said conductive contiguity comprises at least one distinct first induced electrical contact portion that, when said conductive contiguity is in a first configuration, does not contact a conductor underlying said conductive contiguity.

113. An electrical switch apparatus as described in claim 112 wherein said at least one distinct first induced electrical contact portion comprises a truncated leg.

114. An electrical switch apparatus as described in claim 112 wherein said at least one distinct first induced electrical contact portion contacts a first electrical event conductor when said conductive contiguity is in a second configuration.

115. An electrical switch apparatus as described in claim 87 wherein said conductive contiguity comprises at least one distinct second induced contact portion.

116. An electrical switch apparatus as described in claim 115 wherein said at least one distinct second induced contact portion comprises a center portion of said conductive contiguity.

117. An electrical switch apparatus as described in claim 87 wherein said conductive contiguity is established above an underlying surface.

118. An electrical switch apparatus as described in claim 117 wherein said underlying surface comprises a conductive underlying surface.

119. An electrical switch apparatus as described in claim 117 wherein said underlying surface comprises at least part of a circuit board.

120. An electrical switch apparatus as described in claim 119 wherein said underlying surface comprises electrical conductors.

121. An electrical switch apparatus as described in claim 120 wherein said electrical conductors comprises a first electrical event conductor, a second electrical event conductor, and a conductor that is distinct from said first electrical event conductor and said second electrical event conductor.

122. An electrical switch apparatus as described in claim 120 wherein said first electrical event conductor comprises an electrically isolated second edge electrical conductor, said second electrical event conductor comprises a center electrical conductor, and said conductor that is distinct from said first electrical event conductor and said second electrical event conductor comprises a first edge electrical conductor.

123. An electrical switch apparatus as described in claim 120 wherein said electrical conductors are traces of a circuit board.

124. An electrical switch apparatus as described in claim 120 wherein one of said electrical conductors comprises a power conductor.

125. An electrical switch apparatus as described in claim 87 wherein said conductive contiguity, when established as part of said electrical switch, is unencased.

126. An electrical switch apparatus as described in claim 125 wherein said conductive contiguity, when established as part of said electrical switch, is held in operative position with a canopy.

127. An electrical switch apparatus as described in claim 126 wherein said canopy comprises adhesive tape.

128. An electrical switch apparatus as described in claim 87 further comprising said underlying surface.

129-217. (canceled)
